(19) United States
(12) Patent Application Publication
(10) Pub. No.: US 2024/0280188 A1
(43) Pub. Date: Aug. 22, 2024

(54) SPRING VALVE

(71) Applicants: Brent Raymond Stark, Edmonton (CA); Jeff Eales, Edmonton (CA)

(72) Inventors: Brent Raymond Stark, Edmonton (CA); Jeff Eales, Edmonton (CA)

(21) Appl. No.: 18/170,513

(22) Filed: Feb. 16, 2023

(51) Int. Cl. F16K 31/60; F16K 21/06

(52) U.S. Cl. CPC F16K 31/602; F16K 21/06; F16K 2200/305

(57) ABSTRACT

A spring valve configured to provide automated movement of the control lever thereof so as to return the control lever to the first position. The spring valve includes a body having a first end and a second end configured to be releasably secured to pipes. The body has movably coupled thereto a control lever that is configured to be moved between a first position and a second position. The control lever is operably controlled with a torsion spring that is operably coupled therewith. The torsion spring includes a first end that is operably coupled to a spring end engagement member formed on the body. The second end of the torsion spring is operably coupled to control lever. Control lever includes tab member formed on the lower portion of the control member. The torsion spring is operable to apply torque to the control lever to return to its first position.

### FIELD OF THE INVENTION

The present invention relates generally to valves, more specifically but not by way of limitation, a flow control valve operable to be utilized in a variety of application wherein the valve of the present invention includes a control lever biased with a torsion spring to provide automated closing thereof.

### BACKGROUND

As is known in the art, valves are utilized in a multitude of industrial applications to provide flow control of fluids. Industries such as but not limited to the petrochemical industry can have thousands of valves deployed in a single manufacturing facility. Valves are provided in various sizes and are operably coupled to pipes and provide directional control of where the fluid is routed. Conventional valves are often ball valve type valves wherein the internal component is controlled by a lever wherein the lever is engaged by a user.

One issue with conventional valves is the lever must be controlled in both directions in order to facilitate both opening and closing of the valve. An operator must engage the lever to provide opening of the valve and subsequently engage the lever to provide closing of the valve. While this meets some application needs, there are applications where automated closing would be an improvement.

Accordingly, there is a need for a valve wherein the valve is configured to provide automated closing thereof ensuing a user releasing the control lever.

### SUMMARY OF THE INVENTION

It is the object of the present invention to provide a valve that is configured to automatically move to the closed position wherein the present invention includes a valve body.

Another object of the present invention is to provide an automated valve operable to remain in an open position during engagement by an operator wherein the valve body includes a control lever movably coupled thereto.

Yet a further object of the present invention is to provide a valve that is configured to automatically move to the closed position wherein the present invention further includes a torsion spring.

Still another object of the present invention is to provide an automated valve operable to remain in an open position during engagement by an operator wherein the torsion spring is operably coupled to a portion of the valve body and the control lever.

An additional object of the present invention is to provide a valve that is configured to automatically move to the closed position wherein the control lever further includes a spring engagement member configured to have an end of the torsion spring operably coupled thereto.

Yet a further object of the present invention is to provide an automated valve operable to remain in an open position during engagement by an operator wherein the torsion spring provides movement of the control lever to place in a closed position.

Another object of the present invention is to provide a valve that is configured to automatically move to the closed position wherein the valve of the present invention is provided in alternate sizes.

Still an additional object of the present invention is to provide an automated valve operable to remain in an open position during engagement by an operator wherein the valve body includes formed thereon a torsion spring end engagement member.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a perspective view of an embodiment of the present invention; and

FIG. 2 is a perspective view of an embodiment of the present invention; and

FIG. 3 is a detailed view of an embodiment of the control lever of the present invention; and

FIG. 4 is a detailed view of the torsion spring and control lever of the present invention.

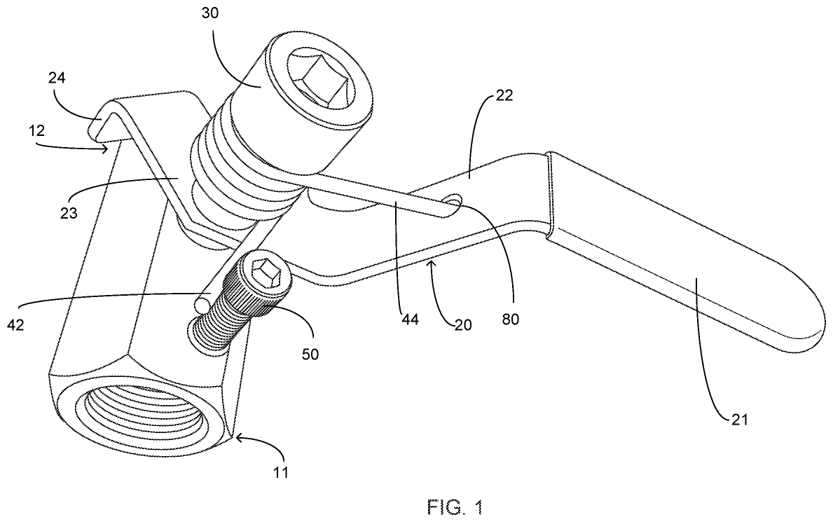

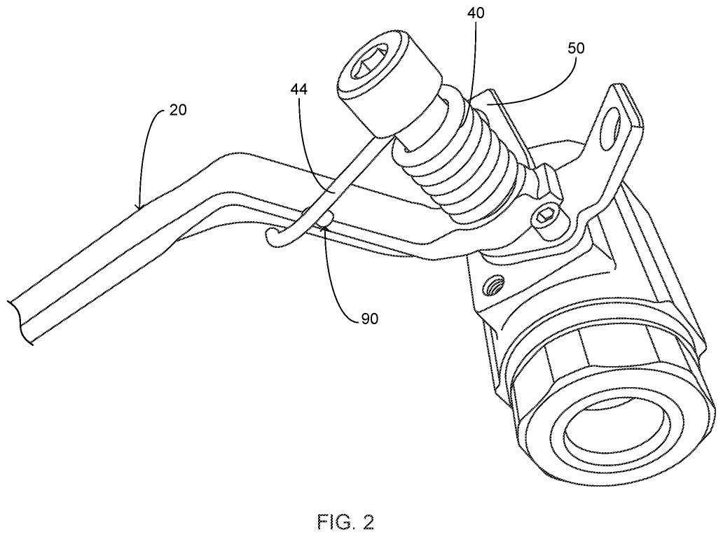

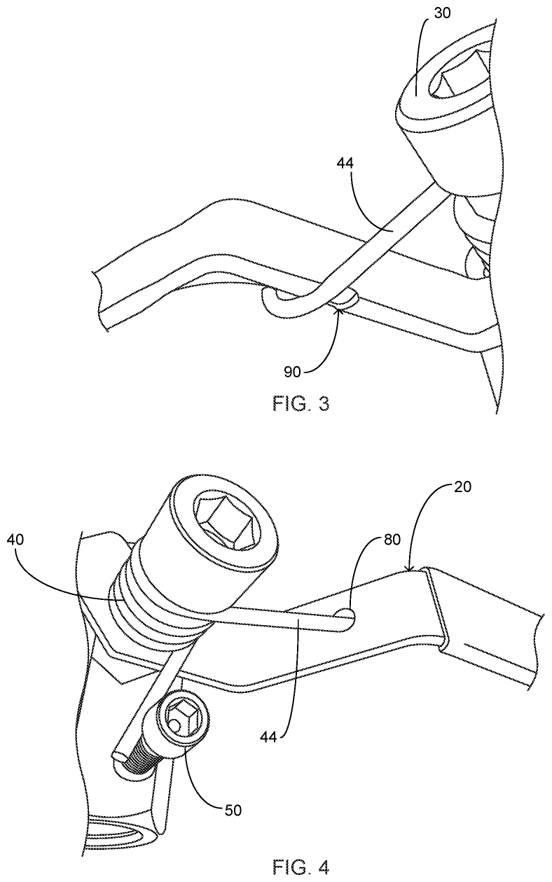

### DETAILED DESCRIPTION

Referring now to the drawings submitted herewith, wherein various elements depicted therein are not necessarily drawn to scale and wherein through the views and figures like elements are referenced with identical reference numerals, there is illustrated a spring valve 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Referring in particular to the Figures submitted herewith, the spring valve 100 includes a body 10. The body 10 is manufactured from a durable rigid material such as but not limited to metal. The body 10 includes first end 11 and second end 12. First end 11 and second end 12 are configured to be operably coupled to pipe ends. It should be understood within the scope of the present invention that the first end 11 and second end 12 could be configured with conventional threads or alternate style of fasteners in order to facilitate the operable coupling of the spring valve 100 to pipes to be employed in a multitude of applications. It should be further understood within the scope of the present invention that the spring valve 100 could be manufactured in alternate sizes.

The spring valve 100 includes control lever 20. Control lever 20 is movable between a first position and a second position wherein movement therebetween provides opening and closing of the spring valve 100 so as to permit or inhibit a flow of fluid therethrough. Control lever 20 includes an upper portion 21 that is contiguously formed with the middle portion 22 and positioned so as to facilitate engagement with a hand of a user of the spring valve 100. The lower portion 23 is rotatably mounted to the body 10 utilizing fastener 30. A tab member 24 is contiguously formed with the lower portion 23 being perpendicular therewith and extending downward therefrom. The tab member 24 inhibits the rotational travel of the control lever 20 by engaging the body 10 functioning to inhibit further movement of the control lever 20.

A torsion spring 40 is mounted around the stem of the fastener 30. The torsion spring 40 functions to provide automated return of the control lever 20 to its first position so as to place the spring valve 100 in a closed position. The torsion spring 40 is manufactured from a durable material such as but not limited to metal and it should be understood within the scope of the present invention that the torsion spring 40 could be provided with alternate levels of torque to suit various applications. The torsion spring 40 includes a first end 42 and a second end 44. First end 42 extends of the lower end of the torsion spring 40 and is operably coupled with a spring end engagement member 50. Second end 44 is operably coupled with the control lever 20. The biased position of the mounting of the torsion spring 40 provides the rotational torque needed to provide movement of the control lever 20 to its first position upon release of the control lever 20 by a user whom had moved the control lever 20 to its second position so as to open the spring valve 100. First end 42 is biased against the spring end engagement member 50 inhibiting movement thereof. As is illustrated herein in FIG. 2, the spring end engagement member 50 can be formed in alternate manners in order to facilitate engagement with first end 42.

The second end 44 can be operably coupled to the control lever 20 in alternate manners as illustrated herein. Illustrated herein in FIG. 1 the control lever 20 includes an aperture 80 wherein the aperture 80 is of suitable size so as to allow the second end 44 to be journaled therethrough so as to facilitate the operable movement of the control lever 20. FIG. 2 and FIG. 3 submitted as a part hereof illustrates a spring end notch member 90. Spring end notch member 90 is formed in the side of control lever 20 and is shaped so as to receive and releasably secure the second end 44 of the torsion spring 40. Employing the spring end notch member 90 the second end 44 is engaged therewith and further has a portion of the second end 44 wrapped around the control lever 20 as illustrated herein.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A spring valve operable to move from a second position to a first position automatically wherein the spring valve comprises:
a body, said body being cylindrical in shape, said body having a first end and a second end, said body being hollow so as to allow a fluid to pass therethrough;
a control lever, said control lever being rotatably coupled to said body, said control lever having an upper portion contiguously formed with a middle portion, said upper portion being angularly oriented with said middle portion and extending outward therefrom, said control lever further having a lower portion, said lower portion having a fastener journaled therethrough, said fastener configured to rotatably secure the control lever to said body, said control lever further having a tab member, said tab member being contiguously formed with said lower portion being perpendicular therewith extending downward therefrom, said control lever having a first position and a second position;
a torsion spring, said torsion spring being surroundably mounted to said fastener, said torsion spring having a first end and a second end, said first end being proximate a bottom of the torsion spring and extending outward therefrom, said second end being proximate an upper end of the torsion spring and extending outward therefrom; and
wherein said second end of said torsion spring is operably coupled to said control lever.

2. The spring valve operable to move from the second position to the first position as recited in claim 1, and further including a spring end engagement member, said spring end engagement member being formed on said body, said spring end engagement member being operably coupled with said first end of said torsion spring.

3. The spring valve operable to move from the second position to the first position as recited in claim 2, wherein said control lever further includes a spring end notch member, said spring end notch member configured to releasably secure a portion of said second end of said torsion spring therein.

4. The spring valve operable to move from the second position to the first position as recited in claim 1, wherein said upper portion of said control lever further includes an aperture, said aperture configured to have said second end of said torsion spring journaled therethrough.

5. The spring valve operable to move from the second position to the first position as recited in claim 4, wherein said torsion spring is configured to provide rotational torque so as to move the control lever from said second position to said first position.

6. The spring valve operable to move from the second position to the first position as recited in claim 5, wherein said tab member is operable to limit rotational travel of said control lever.

7. The spring valve operable to move from the second position to the first position as recited in claim 2, wherein said spring end engagement member is a fastener operably coupled to said body.
